(19) United States
(12) Patent Application Publication
(10) Pub. No.: US 2026/0147145 A1
(43) Pub. Date: May 28, 2026

(54) OPTICAL COMPONENT, OPTICAL ELEMENT, AND MANUFACTURING METHOD OF OPTICAL COMPONENT

(71) Applicant: CANON KABUSHIKI KAISHA, Tokyo (JP)

(72) Inventors: TOMOYUKI AOYAGI, Kanagawa (JP); MASATSUGU KOYAMA, Kanagawa (JP)

(21) Appl. No.: 19/384,462

(22) Filed: Nov. 10, 2025

(30) Foreign Application Priority Data
Nov. 27, 2024 (JP) 2024-206629
Nov. 27, 2024 (JP) 2024-206630

(51) Int. Cl. G02B 5/18; G02B 27/09

(52) U.S. Cl. CPC G02B 5/1814; G02B 27/0944; G02B 27/0966

(57) ABSTRACT

An optical component made of a solid material that transmits light of a used wavelength includes a diffraction grating and a plurality of lenses. The diffraction grating includes a plurality of grooves that extend in a second direction, and disposed on a first optical surface of the optical component on which the light of the used wavelength is incident. The plurality of lenses are arranged in the second direction and provided on a second optical surface of the optical component from which the light of the used wavelength incident from the first optical surface is emitted.

### BACKGROUND

### Field of the Technology

The present disclosure relates to an optical component, an optical element, and the like that can be used in various fields such as astronomical observation and material analysis.

### Description of the Related Art

Hitherto, in various fields such as astronomical observation and material analysis, a spectroscopic device that disperses light for each wavelength, receives the light by a detector, and measures an intensity has been used.

JP 2022-96461 A proposes a plane spectroscopic device including a reflection unit that divides a light flux incident from an object surface side into a plurality of light fluxes and reflects the light fluxes to different positions, an imaging mirror, a spectroscopic element such as a diffraction grating, and a detection unit such as an optical sensor.

In the plane spectroscopic device described in JP 2022-96461 A, incident light is divided into a plurality of light fluxes using the reflection unit, and each of the divided light fluxes is dispersed, whereby two-dimensional spatial information and spectral information can be simultaneously observed. After the incident light is divided into the plurality of light fluxes by the reflection unit, the light is repeatedly reflected by the imaging mirror and the spectroscopic element and guided to the optical sensor. However, it is necessary to secure a large optical path space, and there is a problem that the plane spectroscopic device tends to be increased in size as a whole.

Therefore, there has been a demand for an optical component or an optical element useful for downsizing a spectroscopic device.

### SUMMARY

According to a first aspect of the present disclosure, an optical component made of a solid material that transmits light of a used wavelength includes a diffraction grating and a plurality of lenses. The diffraction grating includes a plurality of grooves that extend in a second direction, and disposed on a first optical surface of the optical component on which the light of the used wavelength is incident. The plurality of lenses are arranged in the second direction and provided on a second optical surface of the optical component from which the light of the used wavelength incident from the first optical surface is emitted.

According to a second aspect of the present disclosure, a manufacturing method of an optical component includes a step of preparing a base material made of a solid material that transmits light of a used wavelength, a step of forming a plurality of grooves, a step of forming a plurality of lenses, and a step of forming a light scattering portion. The plurality of grooves is arranged in a longitudinal direction of the base material on a first surface of the base material. The plurality of lenses is arranged in the longitudinal direction of the base material on a second surface opposite to the first surface. The light scattering portion extends in a traverse direction of the base material and has a surface roughness higher than a surface roughness of the optical surface of the plurality of lenses at a boundary portion between adjacent lenses among the plurality of lenses.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view illustrating a configuration of a spectroscopic device in which an optical element according to an embodiment is incorporated.

FIG. 2A is a schematic perspective view illustrating an optical functional portion that implements an optical function in a transmissive optical element.

FIG. 2B is a perspective view illustrating a shape of one optical component.

FIG. 3 is a partially enlarged view for describing a first optical surface (incident surface).

FIG. 4 is a plan view of a second optical surface (emitting surface) when viewed in plan from a direction in which a light flux is emitted.

FIG. 5 is a schematic view illustrating an arrangement of light fluxes incident on a light receiving surface of a light receiving sensor.

FIG. 6A is a schematic plan view of the second optical surface (emitting surface) of the optical component.

FIG. 6B is a schematic view illustrating a trajectory of one scan when a cutting tool scans a portion between LB and LB in FIG. 6A to produce a lens surface.

FIG. 6C is a schematic view illustrating a trajectory of one scan when the cutting tool scans a portion between LM and LM in FIG. 6A to produce a lens boundary portion.

FIG. 7 is a view illustrating an XZ cross section of a two-dimensional lens array according to the embodiment.

FIG. 8A is a perspective view illustrating an example of the shape of the optical component.

FIG. 8B is a perspective view illustrating another example of the shape of the optical component.

FIG. 9 illustrates an example of the optical element including a component for positioning and fixing a plurality of optical components.

FIG. 10 illustrates another example of the optical element including the component for positioning and fixing the plurality of optical components.

FIG. 11A is a view illustrating a base material according to a comparative embodiment.

FIG. 11B is a view illustrating a method of producing a lens in the comparative embodiment.

FIG. 11C is a view illustrating a lens array according to the comparative embodiment.

FIG. 12A is an XZ cross-sectional view schematically illustrating a path of light transmitted through an optical element according to the comparative embodiment.

FIG. 12B is an XZ cross-sectional view schematically illustrating a path of light transmitted through the optical element according to the embodiment.

FIG. 13A is a YZ cross-sectional view schematically illustrating a path of light transmitted through the optical element according to the comparative embodiment.

FIG. 13B is a YZ cross-sectional view schematically illustrating a path of light transmitted through the optical element according to the embodiment.

### DESCRIPTION OF THE EMBODIMENTS

An optical component, an optical element, and the like according to an embodiment of the present disclosure will be described with reference to the drawings. The embodiments to be described below are examples, and detailed configurations can be appropriately modified for implementation by those skilled in the art without departing from the gist of the present disclosure. Each of the embodiments of the present disclosure described below can be implemented solely or as a combination of a plurality of the embodiments or features thereof where necessary or where the combination of elements or features from individual embodiments in a single embodiment is beneficial.

Meanwhile, it should be noted that, in the drawings referred to in the following description of embodiments, elements denoted by the same reference numerals have the same functions unless otherwise specified. In the drawings, in a case where a plurality of identical elements are arranged, the reference numerals and explanations thereof may be omitted.

In addition, since the drawings may be schematically represented for convenience of illustration and description, shapes, sizes, arrangements, and the like of elements illustrated in the drawings may not exactly coincide with actual objects. In addition, “XX or more and YY or less” or “XX to YY” indicating a numerical range means a numerical range including end points XX (lower limit) and YY (upper limit) unless otherwise specified. When numerical ranges are described in stages, the upper limits and the lower limits of the respective numerical ranges can be combined in any manner.

In the following description, for example, a +X direction refers to a direction indicated by an X-axis arrow in the illustrated orthogonal coordinate system, and a −X direction refers to a direction 180-degree opposite to the direction indicated by the X-axis arrow in the illustrated orthogonal coordinate system. In addition, when an X direction is simply mentioned, the X direction refers to a direction parallel to an X axis regardless of whether the X direction is different from the direction indicated by the illustrated X-axis arrow. The same applies to directions other than the X direction.

### First Embodiment

### Overall Configuration of Spectroscopic Device

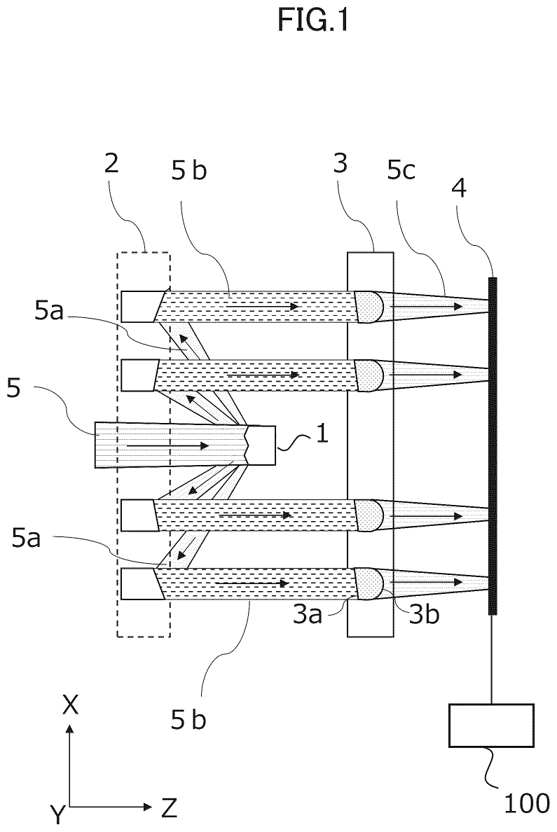

FIG. 1 is a schematic view illustrating a configuration of a spectroscopic device in which an optical component and an optical element according to an embodiment are incorporated. The spectroscopic device includes a beam splitter 1, a mirror 2, a transmissive optical element 3, a light receiving sensor 4, and an information processing device 100. An optical system including the beam splitter 1, the mirror 2, and the transmissive optical element 3 can also be referred to as a spectroscopic optical system.

Incident light 5 (observation light) to be observed travels in a +Z direction and is incident on the beam splitter 1 in the device. A reflective surface of the beam splitter 1 is formed such that the incident light 5 is split into a plurality of light fluxes 5a, and the light fluxes 5a are reflected in different directions. The beam splitter 1 and the mirror 2 are formed such that each of the light fluxes 5a reflected in different directions is directed to one of a plurality of mirrors 2 arranged in a distributed manner. The plurality of mirrors 2 are arranged along a curved surface centered on an optical axis of the incident light 5. The number of divisions, which represents the number of light fluxes 5a into which the incident light 5 is split by the beam splitter 1, and the number of mirrors 2 are the same as each other.

Each of the light fluxes 5a reflected by the beam splitter 1 in different directions is incident on one of the plurality of mirrors 2 and is reflected as a light flux 5b by the mirror 2. A reflective surface of the mirror 2 is a concave surface, and an optical axis of each light flux 5b is parallel to a +Z direction. Each light flux 5b is incident on a first optical surface 3a (incident surface) of the optical element 3.

Although the transmissive optical element 3 will be described in detail below, a plurality of diffraction gratings DF are provided on the first optical surfaces 3a (incident surfaces), and a plurality of convex lenses CL are provided on a second optical surface 3b (emitting surface). The light flux 5b incident on each diffraction grating DF is dispersed according to a wavelength and is emitted from any one of the convex lenses CL as a light flux 5c.

The light flux 5c emitted from the second optical surface 3b (emitting surface) is condensed on a light receiving surface of the light receiving sensor 4. The light receiving sensor 4 is a two-dimensional imaging device having sensitivity to a wavelength band of the incident light 5, and transmits a measurement result to the information processing device 100. The information processing device 100 is a computer that performs information processing regarding plane spectroscopy, and calculates two-dimensional spatial information and spectral information regarding the incident light 5 based on the measurement result of the light receiving sensor 4. In a case where the light receiving sensor 4 captures a moving image, the information processing device 100 can also acquire a temporal change of the two-dimensional spatial information and the spectral information.

### Configuration of Transmissive Optical Element

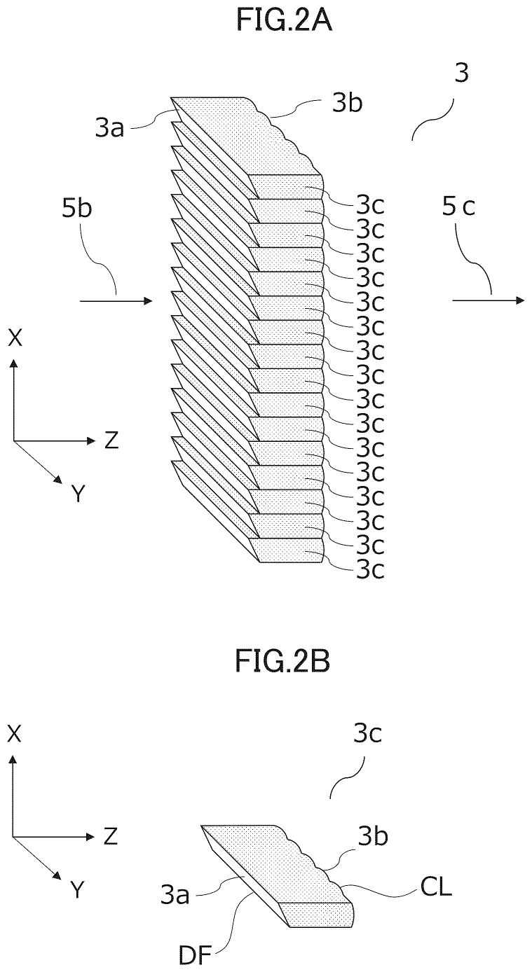

FIG. 2A is a schematic perspective view illustrating an optical functional portion that performs an optical function in the transmissive optical element 3. In addition to the optical functional portion, the transmissive optical element 3 may include a support portion for positioning and fixing a plurality of optical components 3c, a fixing portion for mounting the optical element on the spectroscopic device, and the like. In the optical functional portion, the plurality of optical components 3c having substantially the same shape are arranged adjacent to each other in the X direction (first direction). Here, the substantially same shape refers to the shapes being identical except for manufacturing tolerances.

FIG. 2B is a perspective view illustrating the shape of one optical component 3c. The optical component 3c is made of a solid material that transmits light of a used wavelength (incident light to be observed), and has the first optical surface 3a (incident surface) on which the light flux 5b is incident and the second optical surface 3b (emitting surface) from which the transmitted light is emitted. In the optical component 3c, the second optical surface 3b (emitting surface) can be disposed on a side opposite to the first optical surface 3a (incident surface).

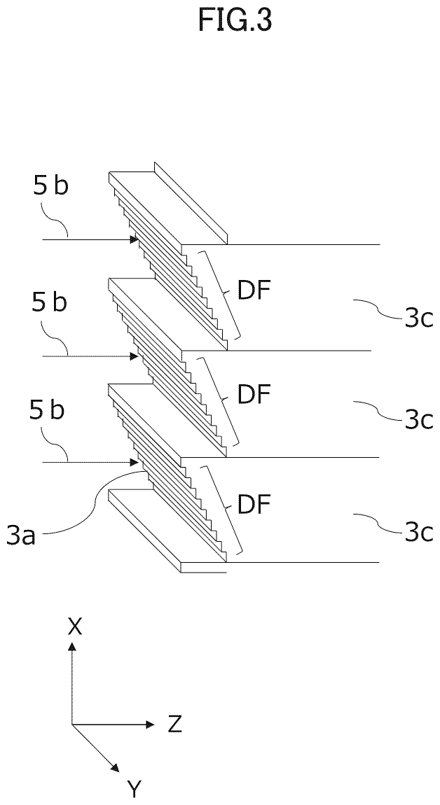

FIG. 3 is a partially enlarged view for describing the first optical surface 3a (incident surface) of the optical component 3c. In a macroscopic view, the first optical surface 3a is an inclined surface in which a normal line from the first optical surface 3a is inclined with respect to the optical axis of the incident light flux 5b. Further, in a microscopic view of the first optical surface 3a, a large number of grooves extending in a longitudinal direction (Y direction) of the optical component 3c are formed on the inclined surface as illustrated in FIG. 3. That is, each optical component 3c includes, on the first optical surface 3a, the diffraction grating DF including the plurality of grooves (for example, V-shaped grooves having a V-shaped cross section) extending in the Y direction (second direction) intersecting the X direction (first direction). The light flux 5b incident on each optical component 3c is diffracted in the X direction according to the wavelength by an action of the diffraction grating DF, and travels toward the second optical surface 3b (emitting surface) in the optical component 3c.

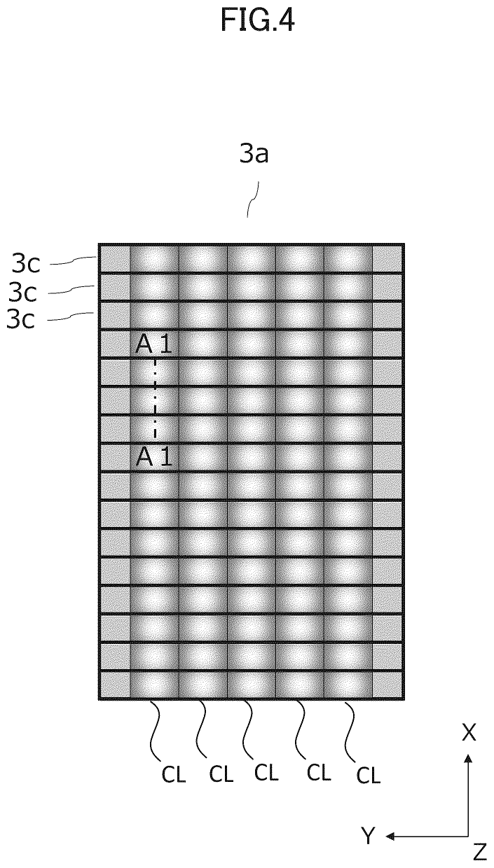

The plurality of convex lenses CL are arranged adjacent to each other in a line along the Y direction (second direction) intersecting the X direction (first direction) on the second optical surface 3b (emitting surface) of each optical component 3c. FIG. 4 is a plan view of the second optical surface 3b (emitting surface) of the optical element 3 when viewed in plan from a Z direction (a direction in which the light flux 5b is emitted). In this example, 16 optical components 3c are arranged adjacent to each other in the X direction (first direction). In each optical component 3c, five convex lenses CL are arranged adjacent to each other in a line along the Y direction (second direction). As described above, a lens array in which 16×5 convex lenses CL are two-dimensionally arranged is formed on the second optical surface 3b (emitting surface) of the optical element 3. The number of optical components 3c is not limited to 16, and the number of the convex lenses CL per one optical component 3c is not limited to five. A configuration of the lens array can be appropriately changed according to a specification of the spectroscopic device.

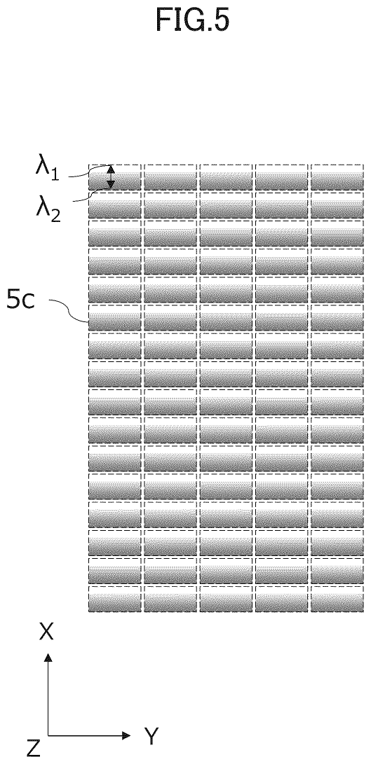

As described with reference to FIG. 1, the light fluxes 5c emitted from the respective convex lenses CL are condensed on the light receiving surface of the light receiving sensor 4. FIG. 5 is a schematic view illustrating an arrangement of the light fluxes 5c incident on the light receiving surface of the light receiving sensor 4 from the optical element 3. The light receiving surface of the light receiving sensor 4 has 16×5 regions on which the light fluxes 5c are condensed from 16×5 convex lenses CL, respectively. In each region, a large number of two-dimensionally arranged pixels are disposed, and a light image emitted from the optical element 3 can be captured.

Since each light flux 5c is dispersed in the X direction according to the wavelength by the action of the diffraction grating DF, for example, rays of light having a wavelength λ1 to a wavelength λ2 are emitted to different positions in the X direction in each of 16×5 regions. For this reason, the two-dimensional spatial information and the spectral information of the incident light 5 (FIG. 1) to be observed can be acquired from imaging data of the light receiving sensor 4.

### Manufacturing Method of Transmissive Optical Element

A manufacturing method of the transmissive optical element 3 will be described. First, a method of producing the optical component 3c will be described, and next, a method of assembling the optical element 3 using the plurality of optical components 3c will be described.

A material of the optical component 3c can be selected from materials that transmit light in a wavelength band to be observed, and for example, calcium fluoride can be used for visible light, and germanium or indium phosphide can be used for infrared light. In order to suppress disturbances of an optical path of the transmitted light in the optical component 3c, a refractive index distribution inside the component is desirably as small as possible, and the optical component 3c is desirably made of a single crystal material.

In the case of a spectroscopic device that disperses infrared light (for example, a wavelength of 1 μm or more and 20 μm or less), the optical component 3c can be manufactured by performing processing such as cutting on a long plate-shaped base material cut out from a single crystal material such as germanium or indium phosphide.

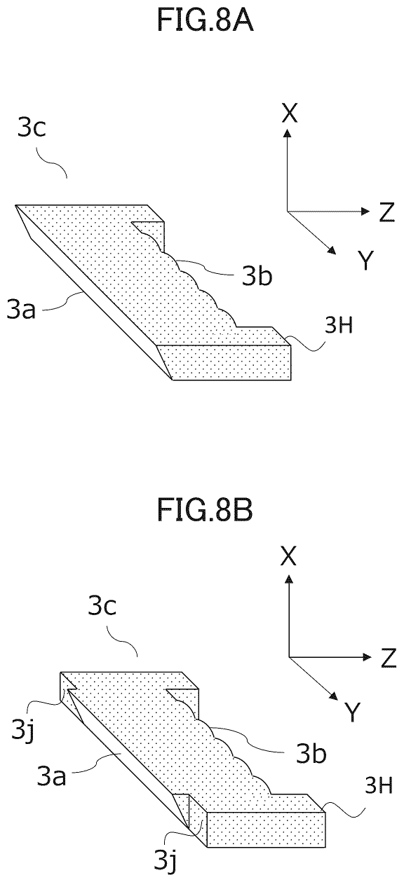

FIG. 8A is a perspective view illustrating an example of the shape of the optical component 3c, and the optical component 3c includes the optical functional portion having the first optical surface 3a (incident surface) and the second optical surface 3b (emitting surface), and fixing portions 3H for positioning and fixing when mounting the optical component 3c on the optical element 3.

First, the long plate-shaped base material is cut to form a schematic shape of the optical component 3c. Thereafter, precise cutting is performed to produce the diffraction grating DF of the first optical surface 3a (incident surface) and the convex lens CL of the second optical surface 3b (emitting surface). Either the diffraction grating DF of the first optical surface 3a (incident surface) or the convex lens CL of the second optical surface 3b (emitting surface) may be produced first.

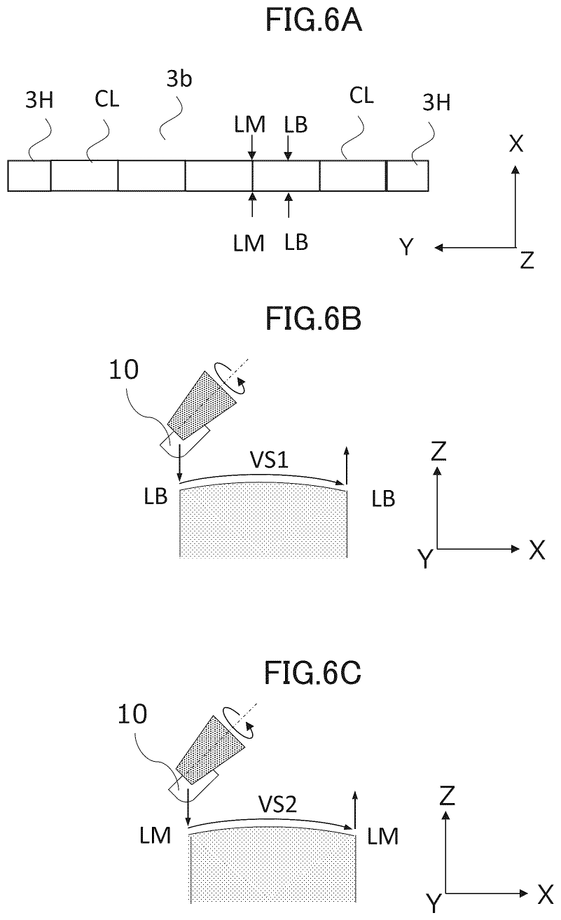

A step of producing the convex lens CL of the second optical surface 3b (emitting surface) will be described. FIG. 6A is a schematic view of the second optical surface 3b (emitting surface) of the optical component 3c when viewed in plan, and five convex lenses CL adjacent to each other in a longitudinal direction of the base material are produced between the fixing portions 3H disposed at both ends of the long plate-shaped base material by precise cutting.

When producing the convex lens CL, a cutting tool is brought into contact with a side surface of the base material to perform cutting, and cutting is performed while scanning the base material with the cutting tool in a traverse direction (X direction) of the base material. Scanning in the X direction is performed while changing a position of the cutting tool in the Z direction according to a curvature of the convex lens CL. Once one scan is completed, the cutting tool is separated from the base material and moved in the Y direction to the next scanning position. By repeating cutting while performing scanning and changing a scanning position in this manner, five convex lenses CL are produced on the second optical surface 3b (emitting surface).

FIG. 6B is a schematic view illustrating a trajectory of one scan in an optical surface producing step in which a cutting tool 10 scans a portion between LB and LB in FIG. 6A to produce a lens surface of the convex lens CL. FIG. 6C is a schematic view illustrating a trajectory of one scan in a boundary portion producing step in which the cutting tool 10 scans a portion between LM and LM in FIG. 6A to produce a lens boundary portion of adjacent convex lenses CL.

It is assumed that a moving speed (scanning speed) of the cutting tool 10 when producing the lens surface is VS1 [mm/s], and a moving speed (scanning speed) of the cutting tool 10 when producing the lens boundary portion is VS2 [mm/s]. A configuration in which VS1=VS2 is possible, but it may be VS1<VS2.

When the moving speed (scanning speed) of the cutting tool 10 is increased, a surface roughness of the base material subjected to cutting is increased. Therefore, in a case where VS1<VS2, a surface roughness of the boundary portion can be made higher than a surface roughness of the lens surface. An optical effect thereof is described below. Furthermore, in a case where VS1<VS2, there is also an effect that a producing time for the optical component 3c can be shortened as compared with a case where the entire first optical surface 3a (incident surface) is produced at a speed of VS1.

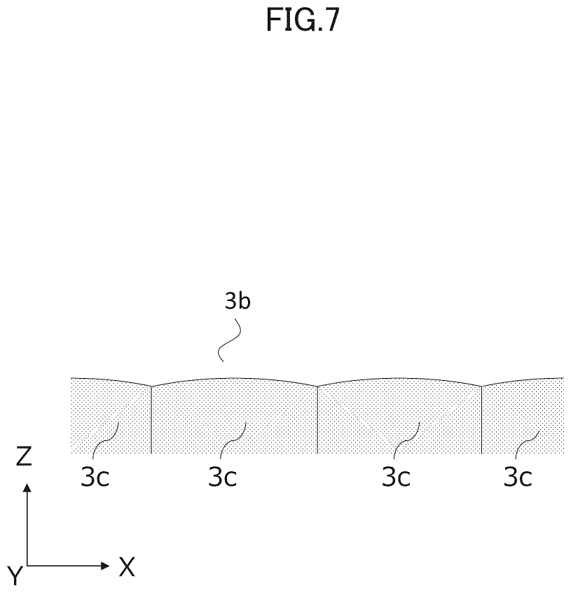

The plurality of optical components 3c produced in this manner are arranged adjacent to each other in the X direction (first direction) as schematically illustrated in FIG. 7. As described above, since the scanning of the portion between LB and LB with the cutting tool 10 is performed at a low speed, when an XZ cross section is viewed in the two-dimensional lens array, the convex lens CL has extremely high shape accuracy even at the boundary portion between the lenses.

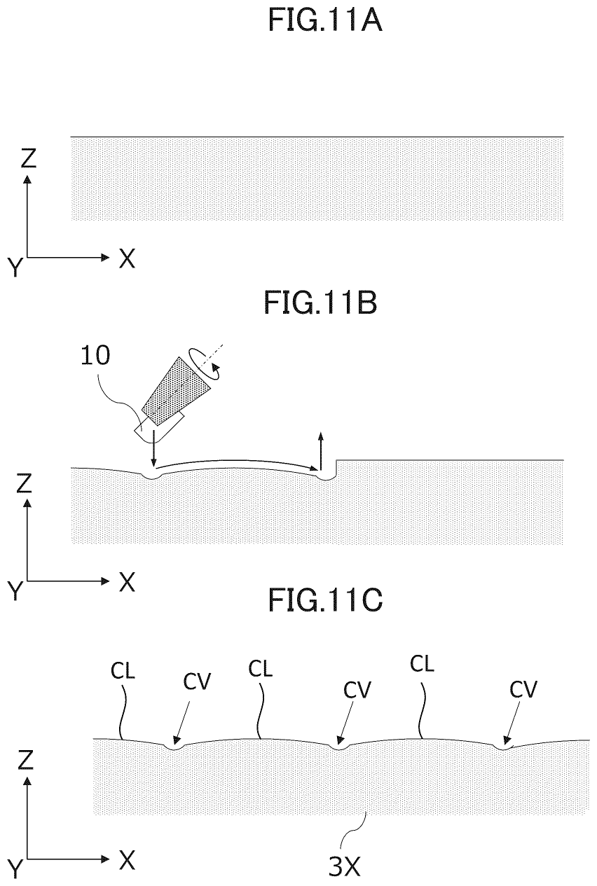

Here, an excellent point of the present embodiment will be described with reference to a comparative embodiment. In the present embodiment, the plurality of optical components 3c are arranged to form the optical element 3, but in the comparative embodiment, an optical element 3X is produced by cutting a single base material. FIGS. 11A to 11C are schematic views illustrating a step of producing a lens array in which convex lenses are two-dimensionally arranged on an incident surface of the optical element 3X according to the comparative embodiment.

In the comparative embodiment, first, as illustrated in FIG. 11A, a base material (for example, a single crystal base material) having a size sufficient for producing the entire optical element 3X is prepared.

Next, as illustrated in FIG. 11B, a cutting tool 10 is brought into contact with the base material to perform cutting in a −Z direction, and cutting is performed while scanning the base material with the cutting tool 10 in the X direction to produce a lens surface of a convex lens CL. A boundary portion between the convex lenses arranged adjacent to each other in the Y direction is also produced by performing scanning with the cutting tool at the same scanning speed as that for the lens surface.

By repeating such a process, as illustrated in FIG. 11C, the lens array in which the convex lenses CL are two-dimensionally arranged is produced on an emitting surface side of the optical element 3X. In particular, in the case of using a single crystal base material, chipping and cracking are likely to occur during cutting. In the comparative embodiment, when chipping and cracking occur even locally, a base material having a size corresponding to the entire optical element 3X is wasted, which is disadvantageous in terms of material usage rate and yield. In the embodiment, however, even if chipping or cracking occurs during cutting, only the optical component needs to be discarded, which is advantageous in terms of material usage rate and yield.

In the comparative embodiment, since a concave portion CV reflecting a tip shape of the cutting tool 10 is formed in the vicinity of the boundary portion between the convex lenses CL adjacent to each other in the X direction, an edge portion of the convex lens CL deviates from an original lens surface shape.

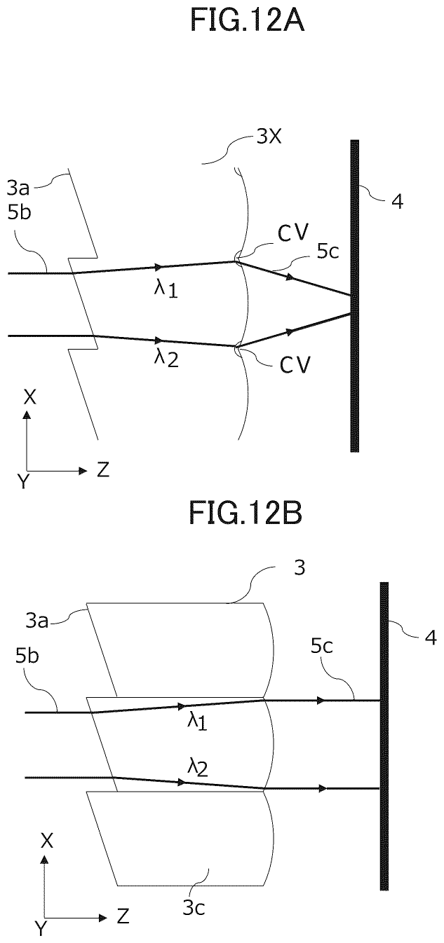

FIG. 12A is an XZ cross-sectional view schematically illustrating a path of light transmitted through the optical element 3X according to the comparative embodiment, and the concave portion CV different from the original lens surface shape is formed at the edge portion of each of the convex lenses CL adjacent to each other in the X direction. Since the light flux 5c emitted from the concave portion CV travels on an optical path different from the original optical path as illustrated in FIG. 12A, noise light that does not correctly reflect the two-dimensional spatial information and the spectral information of the incident light 5 (FIG. 1) to be observed can be generated.

FIG. 12B is an XZ cross-sectional view schematically illustrating a path of light transmitted through the optical element 3 according to the embodiment. As described with reference to FIG. 6B, in the present embodiment, when producing the convex lens CL, the cutting tool is brought into contact with the side surface of the base material to perform cutting, and cutting is performed while scanning the base material with the cutting tool in the traverse direction (X direction) of the base material. Therefore, in each of the convex lenses CL adjacent to each other in the X direction, the original lens surface shape is formed with high accuracy even at the edge portion of the lens. Therefore, as illustrated in FIG. 12B, the emitted light flux 5c can travel along the original optical path. According to the present embodiment, light reflecting the two-dimensional spatial information and the spectral information of the incident light 5 (FIG. 1) to be observed can be guided to the light receiving surface of the light receiving sensor 4.

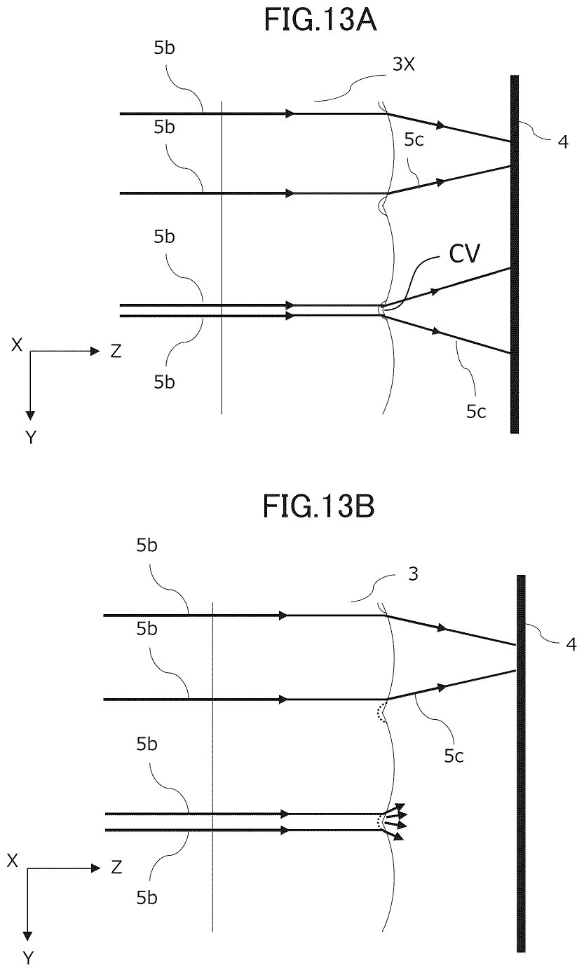

FIG. 13A is a YZ cross-sectional view schematically illustrating a path of light transmitted through the optical element 3X according to the comparative embodiment, and the concave portion CV different from the original lens surface shape is formed at the edge portion of each of the convex lenses CL adjacent to each other in the Y direction. The concave portion CV is formed by moving the cutting tool at the same scanning speed as that for the lens surface, and has a low surface roughness, as a result of which a light transmittance is high. Since the light flux 5c emitted from the concave portion CV travels on an optical path different from the original lens surface shape as illustrated in FIG. 13A, noise light that does not reflect the two-dimensional spatial information of the incident light 5 (FIG. 1) to be observed can be generated.

FIG. 13B is an XZ cross-sectional view schematically illustrating a path of light transmitted through the optical element 3 according to the embodiment. As described with reference to FIG. 6C, in a desirable embodiment, the moving speed (scanning speed) of the cutting tool 10 when producing the lens boundary portion is set such that VS1<VS2, and the surface roughness of the boundary portion is made higher than the surface roughness of the lens surface, thereby forming a light scattering portion at the boundary portion. Since the emitted light is scattered at a wide angle in the lens boundary portion (light scattering portion) having a high surface roughness, noise light having a high intensity is not locally incident on a specific position (pixel) on the light receiving surface of the light receiving sensor 4. In this manner, generation of the noise light that does not reflect the two-dimensional spatial information of the incident light 5 (FIG. 1) to be observed is suppressed.

Here, returning to the description of the manufacturing method of the transmissive optical element, a step of producing the optical element 3 using the plurality of optical components 3c will be described. For example, an adhesive is applied to each side surface of the optical component 3c illustrated in FIG. 2B, the optical components 3c are arranged in the X direction using a positioning jig (not illustrated), and the adhesive is solidified, thereby integrating the optical components 3c as illustrated in FIG. 2A to produce the optical element.

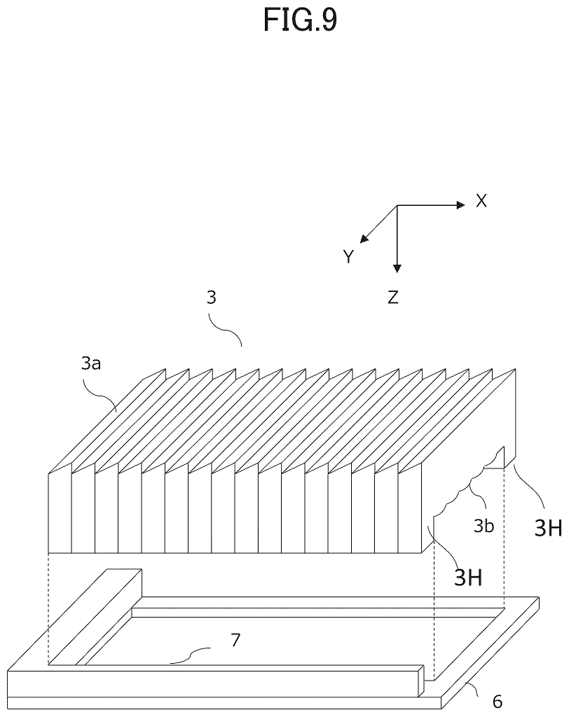

In addition, the optical element may include a component for positioning and fixing the plurality of optical components. For example, as illustrated in FIG. 9, the optical component 3c illustrated in FIG. 8A may be positioned and fixed using a frame body 6 (support member) provided with an opening portion and an L-shaped component 7 (positioning reference) fixed to the frame body 6. The fixing portions 3H of the optical components 3c may be arranged while contacting the L-shaped component 7 serving as the positioning reference, and the optical components 3c may be fixed to the frame body 6 using the adhesive.

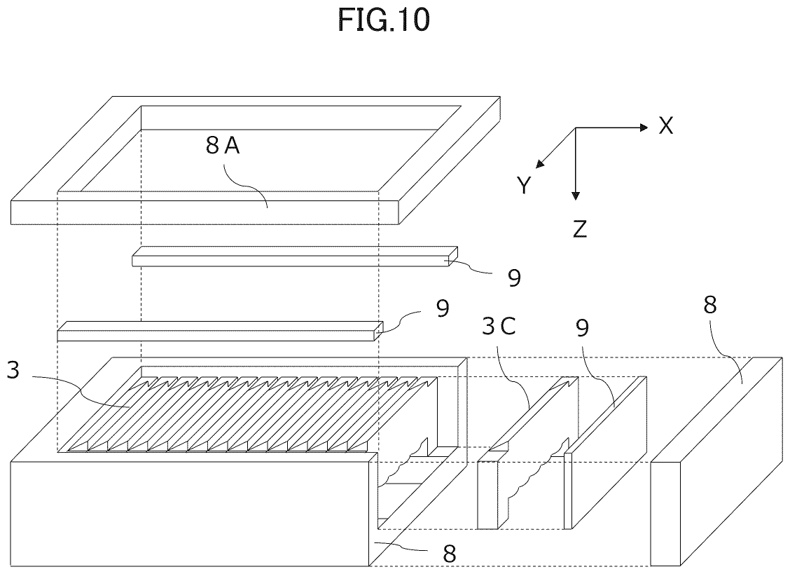

The optical component 3c is not necessarily fixed with the adhesive and may be positioned and fixed using a flexible member such as an elastic member. For example, as illustrated in FIG. 10, the optical component 3c illustrated in FIG. 8B may be positioned and fixed using a holder 8 provided with an opening portion, a frame-shaped lid 8A, and an elastic rubber member 9. The optical component 3c is stored in the holder 8 while being pressed in the −X direction through the sheet-shaped rubber member 9. The frame-shaped lid 8A may press a notch portion 3j (FIG. 8B) of the optical component 3c in the +Z direction via the elongated rubber member 9 to position and fix the optical component 3c in the holder 8.

According to the embodiment, since the optical element 3 including the plurality of optical components 3c is used, it is not necessary to repeat reflection using an imaging mirror and a spectroscopic element as in a related art, so that an optical path space becomes compact as illustrated in FIG. 1, and the plane spectroscopic device can be downsized.

### Modified Embodiment

The present disclosure is not limited to the embodiments described above, and many modifications can be made within the technical spirit of the present disclosure. For example, all or some of the optical components having different shapes described above may be combined for implementation.

Although the diffraction grating DF formed on the inclined surface is illustrated in FIG. 3, the diffraction grating DF may be formed by providing a V-shaped groove on a surface orthogonal to the optical axis of the incident light flux 5b. An apex angle and the number of V grooves included in the diffraction grating DF can be set according to a wavelength band of light to be observed.

Although there is a possibility that unnecessary light or stray light is incident on the optical element 3 from a direction inclined with respect to the +Z direction, a light blocking structure may be provided at the boundary portion between the optical components 3c in order to prevent such unnecessary light or stray light from reaching the light receiving sensor 4. For example, a fine uneven shape may be provided by grinding or laser processing on a side surface (a surface connecting the first optical surface and the second optical surface) serving as the boundary portion with an adjacent optical component 3c to suppress transmission of obliquely incident unnecessary light or stray light. In addition, a member having a light blocking property or a coating film may be provided on the side surface (the surface connecting the first optical surface and the second optical surface) serving as the boundary portion with an adjacent optical component 3c. Alternatively, adjacent optical components 3c may be bonded to each other by applying an adhesive containing a material that absorbs unnecessary light to the side surface (the surface connecting the first optical surface and the second optical surface) serving as the boundary portion with an adjacent optical component 3c.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No.2024-206630, filed Nov. 27, 2024, and Japanese Patent Application No. 2024-206629, filed Nov. 27, 2024, which are hereby incorporated by reference herein in their entirety.

What is claimed is:

1. An optical component made of a solid material that transmits light of a used wavelength, the optical component comprising:
a diffraction grating including a plurality of grooves that extend in a second direction, and disposed on a first optical surface of the optical component on which the light of the used wavelength is incident; and
a plurality of lenses arranged in the second direction and provided on a second optical surface of the optical component from which the light of the used wavelength incident from the first optical surface is emitted.

2. The optical component according to claim 1, further comprising
a light scattering portion extending in a first direction intersecting the second direction, having a surface roughness higher than a surface roughness of an optical surface of the lenses, and provided at a boundary portion between adjacent lenses among the plurality of lenses arranged in the second direction.

3. The optical component according to claim 1, wherein
the first optical surface is an inclined surface disposed such that a normal line from the first optical surface is inclined with respect to an optical axis of the light of the used wavelength to be incident, and the diffraction grating is formed on the inclined surface.

4. The optical component according to claim 1, wherein
the solid material is a single crystal material.

5. The optical component according to claim 1, wherein
the solid material is a material containing indium phosphide or germanium.

6. The optical component according to claim 1, wherein
the used wavelength is 1 μm or more and 20 μm or less.

7. The optical component according to claim 1, further comprising
a light blocking structure provided on a surface connecting the first optical surface and the second optical surface.

8. An optical element comprising:
a plurality of optical components, each of the plurality of optical components is the optical component according to claim 1,
wherein the plurality of optical components are arranged adjacent to each other in a first direction intersecting the second direction.

9. The optical element according to claim 8, further comprising
a light blocking structure disposed at a boundary portion between optical components arranged adjacent to each other in the first direction among the plurality of optical components.

10. A manufacturing method of an optical component, the manufacturing method comprising:
a step of preparing a base material made of a solid material that transmits light of a used wavelength;
a step of forming a plurality of grooves, the plurality of grooves being arranged in a longitudinal direction of the base material on a first surface of the base material;
a step of forming a plurality of lenses, the plurality of lenses being arranged in the longitudinal direction of the base material on a second surface opposite to the first surface; and
a step of forming a light scattering portion, the light scattering portion extending in a traverse direction of the base material and having a surface roughness higher than a surface roughness of optical surface of the plurality of lenses at a boundary portion between adjacent lenses among the plurality of lenses.

11. The manufacturing method according to claim 10, wherein
in the step of forming a plurality of grooves, a diffraction grating is formed on the first surface inclined with respect to the second surface.

12. The manufacturing method according to claim 10, wherein
the step of forming a plurality of lenses includes
an optical surface producing step of performing cutting to form the optical surface of the plurality of lenses while moving a cutting tool in a traverse direction of the second surface,
wherein the step of forming a light scattering portion includes a boundary portion producing step of performing cutting to form the boundary portion between the adjacent lenses while moving the cutting tool in the traverse direction of the second surface, and
wherein a speed at which the cutting tool is moved in the optical surface producing step is lower than a speed at which the cutting tool is moved in the boundary portion producing step.

13. The manufacturing method according to claim 10, wherein
the solid material is a single crystal material.

14. The manufacturing method according to claim 10, wherein
the solid material contains indium phosphide or germanium.

15. The manufacturing method according to claim 10, wherein
the used wavelength is 1 μm or more and 20 μm or less.

16. The manufacturing method according to claim 10, further comprising
a step of forming a light blocking structure on a surface connecting the first surface and the second surface.
